(19) United States
(12) Patent Application Publication
(10) Pub. No.: US 2025/0191529 A1
(43) Pub. Date: Jun. 12, 2025

(54) POWER SUPPLY CIRCUIT, CHIP AND DISPLAY SCREEN

(71) Applicant: Chipone Technology (Beijing) Co., Ltd., Beijing (CN)

(72) Inventor: Yingjie MA, Beijing (CN)

(73) Assignee: Chipone Technology (Beijing) Co., Ltd., Beijing, CN (CN)

(21) Appl. No.: 19/054,572

(22) Filed: Feb. 14, 2025

Related U.S. Application Data
(63) Continuation-in-part of application No. 18/256,436, filed on Jun. 8, 2023, now abandoned.

(51) Int. Cl. G09G 3/32; G09G 3/20

(52) U.S. Cl. CPC G09G 3/32; G09G 3/2007; G09G 2330/021

(57) ABSTRACT

The present disclosure relates to a power supply circuit, a chip, and a display screen. The power supply circuit includes a reference circuit and a current mirror circuit. The current mirror circuit mirrors a reference current provided by the reference circuit into a plurality of output currents. The current mirror circuit includes an input branch and a plurality of output branches, both of which receive the same gate driving signal to generate the plurality of output currents. A buffer is used to isolate the plurality of output branches from the input branch and improve the stability of the power supply circuit even when the current ratios of the plurality of output branches are dynamically changed.

### CROSS-REFERENCE TO RELATED APPLICATIONS

This application is a continuation-in-part of U.S. application Ser. No. 18/256,436, filed on Nov. 15, 2021, and entitled “POWER SUPPLY CIRCUIT, CHIP AND DISPLAY SCREEN”, which claims the priority to the Chinese patent application Ser. No. 2020115016417, filed on Dec. 17, 2020, and entitled “POWER SUPPLY CIRCUIT, CHIP AND DISPLAY SCREEN”, the contents of which are incorporated herein by reference in their entirety.

### TECHNICAL FIELD

The present disclosure relates to the technical field of circuits, in particular to a power supply circuit, a chip, and a display screen used in LED driver applications.

### BACKGROUND

An LED (Light Emitting Diode) display screen is a type of flat-panel display composed of small LED module panels, each containing an array of LEDs and multiple driver chips. It is used to display various types of information, including text, images, and videos, and is widely applied in commercial advertising, cultural performances, stadiums, information broadcasting, press releases, and securities trading, catering to diverse environments.

In an LED display screen, multiple driver chips supply currents to the LED array and function as power supply circuits. The effective brightness of an LED determines the grayscale levels of pixels in an image. Each driver chip has multiple outputs that adjust output currents between frames or between different lines within a single frame. These switching actions introduce transient fluctuations into the current mirror circuit within the driver chip, potentially destabilizing the output currents.

### SUMMARY OF THE INVENTIONS

The purpose of the embodiment of the present disclosure is to provide a power supply circuit, a chip, and a display screen, which improves the stability of the power supply circuit even when the output currents are dynamically changed in LED driver applications.

One embodiment of the present disclosure provides a power supply circuit, which comprises: a reference circuit, configured to generate a reference current; a current mirror circuit, configured to be coupled with the reference circuit and mirror the reference current to a plurality of output currents, wherein the current mirror circuit comprises: a gate driver, configured to generate a gate driving signal according to a first reference voltage; an input branch, which receives the gate driving signal and generates an input current according to the gate driving signal; and a plurality of output branches, each of which receives the gate driving signal through a buffer between the input branch and the plurality of output branches, and generates one of the plurality of output currents according to the gate driving signal.

Optionally, the plurality of output branches are coupled with the buffer through a common driving line, so that the buffer is shared by the plurality of output branches.

Optionally, each of the plurality of output branches is coupled with one of a plurality of buffers through respective one of a plurality of driving lines, so that the buffer is dedicated to one of the plurality of output branches.

Optionally, the input branch comprises: a plurality of first switches; and a plurality of first transistors, wherein a drain of each of the first transistors receives the reference current at an input terminal of the input branch, respectively; a gate of each of the first transistors receives the gate driving signal through one of the plurality of first switches; and a source of each of the first transistors is grounded.

Optionally, the gate driver comprises: a first operational amplifier, an inverting input terminal of the first operational amplifier receiving the first reference voltage, and a non-inverting input terminal of the first operational amplifier being coupled to the input terminal of the input branch, and an output terminal of the first operational amplifier being coupled to the gate of each of the first transistors through one of the first switches.

Optionally, each of the plurality of first transistors is an NMOS transistor.

Optionally, each of the plurality of output branches comprises: a plurality of second switches; a plurality of second transistors; an output transistor; and a second amplifier is coupled to the input terminal of the input branch, and an output terminal of the second operational amplifier is coupled to the output transistor, a drain of each of the second transistors is coupled to an inverting input terminal of the second operational amplifier, a gate of each of the second transistors is coupled to the output terminal of the first operational amplifier through one of the plurality of second switches, and a source of each of the second transistors is grounded.

Optionally, each of the plurality of second transistors is an NMOS transistor.

Optionally, the power supply circuit further comprises: a controller, configured to control on and off states of the plurality of first switches and the plurality of second switches, so as to change current ratios of the plurality of output branches.

Optionally, the controller determines the current ratios of the plurality of output branches according to specifications of a display screen.

Optionally, the controller determines the current ratios of the plurality of output branches according to grayscale levels of pixels of an image.

Optionally, the controller determines predetermined current ratios of the plurality of output branches and duty ratios of the plurality of output currents according to grayscale levels of pixels of an image.

Optionally, the reference circuit comprises: an operational amplifier, wherein an inverting input terminal of the operational amplifier receives a second reference voltage; and an external resistor, wherein a first terminal of the external resistor is coupled to a non-inverting input terminal of the operational amplifier, and a second terminal of the external resistor is grounded.

Optionally, the reference circuit further comprises: a third transistor, wherein a gate of the third transistor is coupled to an output terminal of the operational amplifier, a drain of the third transistor is coupled to the first terminal of the external resistor, and a source of the third transistor is grounded; and a fourth transistor, wherein a gate of the fourth transistor is coupled to the output terminal of the operational amplifier, a drain of the fourth transistor is respectively coupled to the drain of each of the first transistors, and a source of the fourth transistor is grounded.

Another embodiment of the present disclosure provides a driver chip, which comprises: the power supply circuit as mentioned above, wherein the power supply circuit provides the plurality of output currents to light-emitting diodes to display an image.

A further embodiment of the present disclosure provides a display screen, which comprises: a plurality of light-emitting diodes; and the driver chip as mentioned above, wherein anodes of the plurality of light-emitting diodes are coupled to a control line, and cathodes of the plurality of light-emitting diodes are coupled to respective ones of a plurality of output terminals of the driver chip; or cathodes of the plurality of light-emitting diodes are coupled to a control line, and anodes of the plurality of light-emitting diodes are coupled to respective ones of a plurality of output terminals of the driver chip.

In LED driver applications, the power supply circuit is used in an LED driver to supply currents to an array of LEDs. The plurality of output branches are coupled to a single input branch to generate multiple output currents based on the specifications of the display screen or the grayscale levels of the pixels in an image. This design reduces the overall circuit cost because the plurality of output branches share one input branch. Additionally, the plurality of output branches are isolated from the single input branch by a buffer. The output branches switch output currents between frames or between different lines within a single frame. The buffer not only provides driving capacity sufficient for all of the output branches but also minimizes the impact of the switching actions of the output branches on a negative feedback circuit of the input branch. As a result, the stability of the power supply circuit is significantly improved, even when the output currents are dynamically changing. The stable output currents further enhance the accuracy of the grayscale levels and the overall display quality of the display screen.

### BRIEF DESCRIPTION OF THE DRAWINGS

To more clearly illustrate the technical solutions of the embodiments of the present disclosure, the drawings used in the embodiments will be briefly introduced below. It should be understood that the following drawings only show some embodiments of the present disclosure and therefore should not be regarded as a limitation on the scope. Those of ordinary skill in the art can also obtain other related drawings based on these drawings without inventive effort.

FIG. 1 illustrates a schematic circuit diagram of an LED module panel in a display screen.

FIG. 2 illustrates a schematic block diagram of a conventional power supply circuit in the LED module panel.

FIG. 3 illustrates a schematic circuit diagram of a first example of a conventional power supply circuit in the LED module panel.

FIG. 4 illustrates a schematic circuit diagram of a second example of a conventional power supply circuit in the LED module panel.

FIG. 5a to 5c illustrate schematic views of circuit equivalent structures of constant-current-source output channels of a conventional power supply circuit in the LED module panel.

FIG. 6 illustrates a schematic block diagram of a power supply circuit in the LED module panel according to an embodiment of the present disclosure.

FIG. 7 illustrates a schematic circuit diagram of a first example of a power supply circuit in the LED module panel according to an embodiment of the present disclosure.

FIG. 8 illustrates a schematic circuit diagram of a second example of a power supply circuit in the LED module panel according to an embodiment of the present disclosure.

### DETAILED DESCRIPTION

The technical solutions in the embodiments of the present disclosure will be described below referring to the drawings in the embodiments of the present disclosure. In the description of the present disclosure, the terms “first”, “second” and the like are only used for distinguishing descriptions and cannot be understood as indicating or implying relative importance.

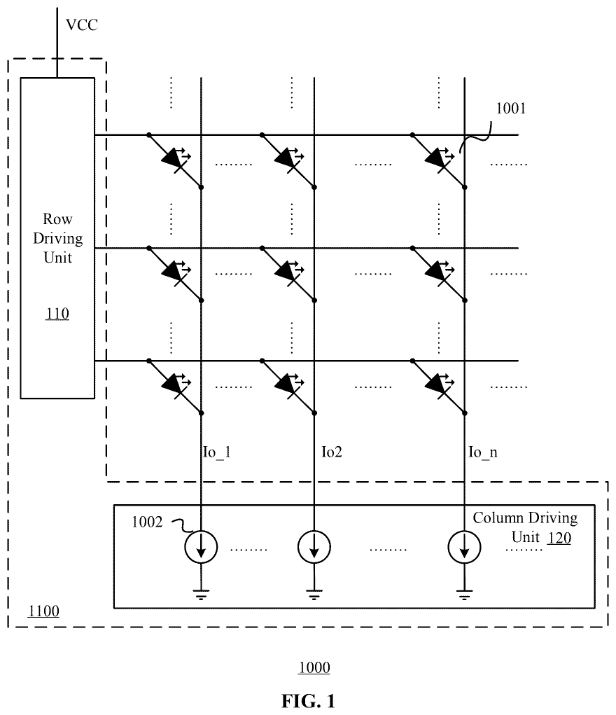

FIG. 1 illustrates a schematic circuit diagram of an LED module panel in a display screen. The LED module panel 1000 includes an array of LEDs 1001 and a driver chip 1100. Each pixel of an image may be displayed with one or more LEDs. In a full-color display screen, one pixel may be displayed with three LEDs, including a red LED, a green LED, and a blue LED. In FIG. 1, only one diode is shown for one pixel, for the purpose of simplicity.

The array of LEDs 1001 is arranged in rows and columns. In a common anode configuration, anodes of LEDs 1001 in a row are coupled with each other and further coupled with a row driving unit 110 in the driver chip 1100, and cathodes of LEDs 1001 in a column are coupled with each other and further coupled with a column driving unit 120. In a common cathode configuration, cathodes of LEDs 1001 in a row are coupled with each other and further coupled with a row driving unit 110 in the driver chip 1100, and anodes of LEDs 1001 in a column are coupled with each other and further coupled with a column driving unit 120. In the example shown in FIG. 1, the array of LEDs 1001 is arranged in the common anode configuration.

The row driving unit 110 selectively couples one row of LEDs with a power supply VCC. The column driving unit 120 includes a plurality of current sources 1002 which supply output currents to the LEDs in the one row of LEDs. Each of the output currents has an amplitude or a duty ratio corresponding to a gray scale level, so that the effective brightness of an LED determines the grayscale levels of pixels in an image. In a frame cycle of display, the array of LEDs 1001 is scanned row by row, enabling the display of an area of an image or text content on the screen. A plurality of LED module panels may be assembled together to show a complete image or text content.

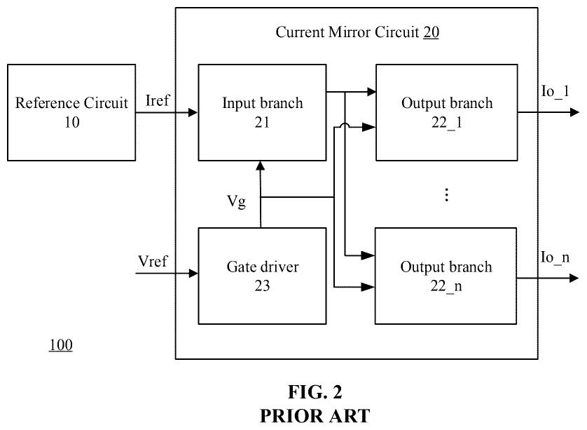

FIG. 2 illustrates a schematic block diagram of a conventional power supply circuit in the LED module panel. The power supply circuit 100 includes a reference circuit 10 and a current mirror circuit 20.

The reference circuit 10 generates a reference current Iref, and the current mirror circuit 20 is coupled with the reference circuit 10 and mirror the reference current Iref to a plurality of output currents Io_1 to Io_n. Thus, the power supply circuit 100 has a plurality of output channels, each of which functions as a current source 1002 shown in FIG. 1.

The current mirror circuit 20 includes an input branch 21 and a plurality of output branches 22-1 to 22_n, and a gate driver 23. The input branch 21 receives the reference current Iref, and each of the plurality of output branches 22-1 to 22_n is coupled with the input branch 21 and generates respective one of the output currents Io_1 to Jo_n. The gate driver 23 generates a gate driving signal Vg according to a first reference voltage Vref, and provides the gate driving signal Vg to the input branch 21 and the plurality of output branches 22-1 to 22_n.

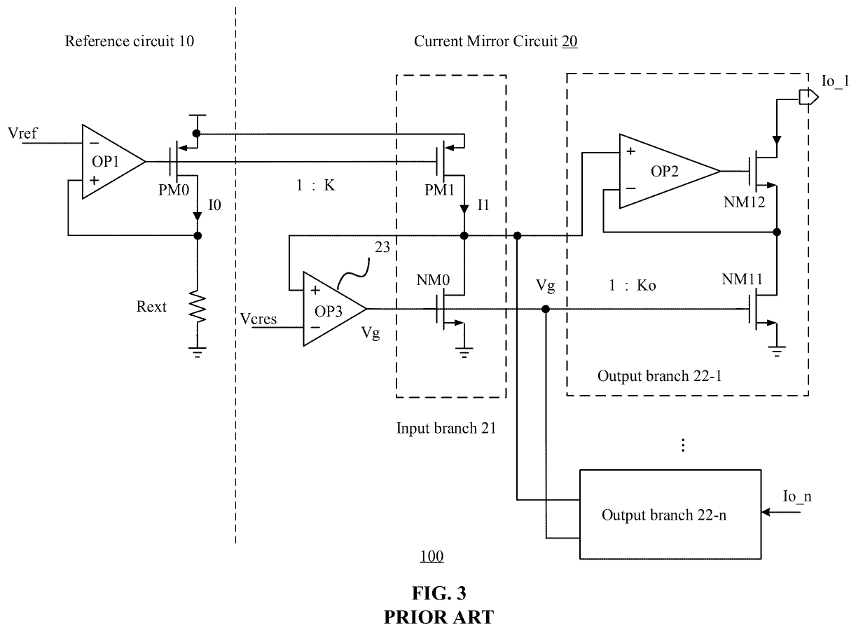

FIG. 3 illustrates a schematic circuit diagram of a first example of a conventional power supply circuit in the LED module panel. Compared with the block diagram shown in FIG. 2, More detailed description of the power supply circuit 100 are shown in FIG. 3.

The reference circuit 10 includes an operational amplifier OP1, a transistor PM0, and a resistor Rext. A first reference voltage Vref is generated by a bandgap circuit not shown here. The transistor PM0 and the resistor Rext are connected in series between a power supply and ground. The operational amplifier OP1 has an inverting input for receiving the first reference voltage Vref, and a non-inverting input coupled with an intermediate node between the transistor PM0 and the resistor Rext, and an output coupled to the gate of the transistor PM0.

The operational amplifier OP1 forms a negative feedback circuit with the transistor PM0, ensuring a stable output voltage through a negative feedback mechanism. If the voltage at the intermediate node increases, the output voltage of the operational amplifier OP1 will correspondingly decrease. Consequently, the voltage difference between the first reference voltage Vref and the node voltage is maintained. Due to the high gain characteristic of the operational amplifier, this voltage difference is very small. The node voltage is approximately equal to the first reference voltage Vref, thus obtaining a reference current I0 as follows:

$$I 0 = \frac{V ref}{Rext}$$

where Vref represents the first reference voltage, and Rext represents a resistance value of the resistor in the reference circuit.

The design of this reference circuit makes the reference current I0 insensitive to external conditions such as supply voltage fluctuations and temperature variations, thus providing a stable reference current that can be used in more complex circuit designs, such as current mirror circuits or other applications requiring precise current control.

In the present disclosure, the transistor may be implemented using various types of transistors, including bipolar junction transistors (BJTs) and field-effect transistors (FETs). BJTs are classified into NPN and PNP types and are essentially current-controlled devices capable of amplifying weak signals due to their gain characteristics. On the other hand, FETs, which include junction field-effect transistors (JFETs) and metal-oxide-semiconductor field-effect transistors (MOSFETs), control current through an electric field and are commonly used in applications requiring high input impedance and low power consumption.

Specifically, in the reference circuit 10, the transistor PM0 is a P-type MOSFET, allowing the external resistor Rext to be grounded and ensuring that the reference current I0 remains insensitive to supply voltage fluctuations. Alternatively, the transistor PM0 may be replaced with an N-type MOSFET in cases where the supply voltage is precise and stable. Furthermore, the transistor PM0 may be replaced with a BJT.

The input branch 21 includes transistors PM1 and NM0, which are coupled between the power supply and the ground. The gate of transistor PM1 is coupled with the gate of transistor PM0, and the source of transistor PM1 is coupled with the source of transistor PM0, forming a first current mirror with a current ratio of K.

Each of the plurality of output branches 22_1 to 22_n includes transistors NM11 and NM12, which are coupled between the power supply and the ground, and an operational amplifier OP2. The gate of transistor NM11 is coupled with the gate of transistor NM0. A non-inverting input terminal of the operational amplifier OP2 is coupled with an intermediate node between the transistors NM11 and NM12, and an inverting input terminal of the operational amplifier OP2 is coupled with an intermediate node between the transistors PM1 and NM0. Further, an output terminal of the operational amplifier OP2 is coupled with a gate of the transistor NM12. By using a negative feedback loop formed by the operational amplifier OP2 and the transistor NM12, the drain voltage of transistor NM11 is set to be equal to the drain voltage of NM0. Thus, the transistors NM0 and NM11 form a second mirror with a current ratio of Ko.

The gate driver 23 may be an operation amplifier OP3, with an inverting input terminal for receiving a second reference voltage Vcres, a non-inverting input terminal being coupled with the intermediate node between the transistors PM1 and NM0, and an output terminal being coupled with the transistor NM0 in the input output branch 21 and the transistor NM11 in each of the plurality of output branches 22_1 to 22_n. The gate driver 23 generates a gate driving signal Vg. By using a negative feedback loop formed by the operational amplifier OP3 and the transistor NM0, the drain voltage of the transistor NM0 is set to be equal to the second reference voltage Vcres.

In practical applications, the current of a MOSFET is proportional to the size of the device under the same voltage bias. The current ratio between the input branch and the output branch is determined by a size ratio of the transistors in the current mirror. If each of the input branch and the output branch includes a plurality of transistors which are of the same size and coupled with each other in parallel, the current ratio Ko between the input branch and the output branch is determined by a ratio of number of the transistors in the second current mirror, i.e. Ko=N/M, where M represents the number of the transistors being coupled in parallel in the input branch, and N represents the number of the transistors being coupled in parallel in the output branch.

Based on the above-mentioned principles, the input branch 21 of the mirror circuit 20 receives input current I1 which satisfies with

$$I 1 = K \cdot I 0$$

where K represents the current ratio of the first current mirror in the power supply circuit, and I0 represents the reference current provided by the reference circuit 10.

The power supply circuit 100 in the driver chip of the LED includes two current mirrors being cascaded, the output current Iout (i.e. one of Io_1 to Io_n of the plurality of output branches 22-1 to 22_n) satisfies the following relationship:

$$\begin{matrix}Iout = Ko \cdot I 1 \\ Iout = \frac{N \cdot K}{M} \cdot \frac{V ref}{Rext}\end{matrix}$$

where Ko represents the current ratio of the second current mirror in the power supply circuit, M represents the number of the transistors being coupled in parallel in the input branch, N represents the number of the transistors being coupled in parallel in the output branch, Vref represents the first reference voltage, and Rext represents a resistance value of the resistor in the reference circuit.

The desired accurate output current Iout can be obtained by adjusting the external resistor Rext and the ratio of the current mirror.

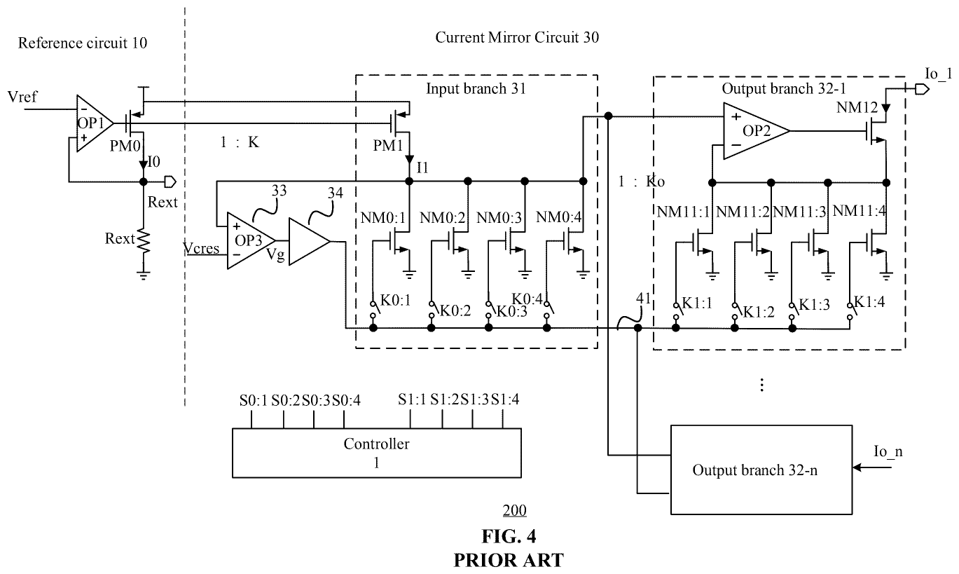

FIG. 4 illustrates a schematic circuit diagram of a second example of a conventional power supply circuit in the LED module panel. The power supply circuit 200 includes a reference circuit 10, a current mirror circuit 30, and a controller 1.

The reference circuit 10 in the second example is the same as that in the first example, thus, the same reference numerals are used FIG. 4 and detailed description of the reference circuit 10 will be omitted.

The current mirror circuit 300 includes an input branch 31 and a plurality of output branches 32-1 to 32_n, a gate driver 33, and a buffer 34. The input branch 31 receives the reference current Iref, and each of the plurality of output branches 32-1 to 32_n is coupled with the inpt branch 31 and generates respective one of the output currents Io_1 to Io_n. The gate driver 33 generates a gate driving signal Vg according to a first reference voltage Vref. Different from the first example, the gate driver 33 provides the gate driving signal Vg to the input branch 31 and the plurality of output branches 32-1 to 32_n, through the buffer 34.

The power supply circuit 200 has a plurality of output branches 32-1 to 32_n to provide multi-channel of output currents. One input branch 31 is shared by the plurality of output branches 32-1 to 32_n in the power supply circuit 100, thereby reducing the overall circuit cost. Moreover, one gate driver 33 is shared by the input branch 31 and the plurality of output branches 32-1 to 32_n to drive mirrored transistors. The buffer 34 is coupled with the gate driver 33 to provide driving capacity sufficient for all of the input branch and the plurality of output branches 32-1 to 32_n.

The input branch 31 includes a transistor PM1, 4 transistors NM0, and 4 first switches K0. The 4 transistors NM0 are coupled in parallel with each other, and then the transistors PM1 is coupled with the 4 transistors NM0 between the power supply and the ground. The gate of transistor PM1 is coupled with the gate of transistor PM0, and the source of transistor PM1 is coupled with the source of transistor PM0, forming a first current mirror with a current ratio of K.

Each of the plurality of output branches 32_1 to 32_n includes 4 transistors NM11, a transistor NM12, 4 second switches K1, and an operational amplifier OP2. The 4 transistors NM11 are coupled in parallel, and then the transistor NM12 is coupled with the 4 transistors NM11 between the power supply and the ground. The gates of the 4 transistors NM0 in the input branch 31 are coupled to a driving line 41 through respective ones of the 4 first switches K0. The gates of the 4 transistors NM11 in each of the plurality of output branches 32_1 to 32_n are coupled to the driving line 41 through respective ones of the 4 second switches K1. A non-inverting input terminal of the operational amplifier OP2 is coupled with an intermediate node between the 4 transistors NM11 and the transistor NM12, and an inverting input terminal of the operational amplifier OP2 is coupled with an intermediate node between the transistors PM1 and the 4 transistors NM0. Further, an output terminal of the operational amplifier OP2 is coupled with a gate of the transistor NM12. By using a negative feedback loop formed by the operational amplifier OP2 and the transistor NM12, the drain voltage of transistor NM11 is set to be equal to the drain voltage of NM0.

The controller 1 generates 4 first switching control signals S0 and 4 second switching control signals Si, to control on and off states of the 4 transistors NM0 and the 4 transistors NM11. Thus, the 4 transistors NM0 and the 4 transistors NM11 form a second mirror with a current ratio of Ko, when at least one of the 4 transistors NM0 and at least one of the 4 transistors NM11 are selected. The current ratio Ko between the input branch and the output branch is determined by a ratio of number of the transistors in the second current mirror, i.e. Ko=N/M, where M represents the number of selected ones of the 4 transistors NM0 in the input branch, and N represents the number of selected ones of the 4 transistors NM11 in the output branch.

The gate driver 33 may be an operation amplifier OP3, with an inverting input terminal for receiving a second reference voltage Vcres, a non-inverting input terminal being coupled with the intermediate node between the transistor PM1 and the 4 transistors NM0, and an output terminal being coupled with the driving line 41 through the buffer 34, and then with the 4 transistors NM0 in the input output branch 31 through respective ones of the 4 first switches K0, and then with the 4 transistors NM11 in each of the plurality of output branches 32_1 to 32_n through respective ones of the second switches K1. The gate driver 33 generates a gate driving signal Vg. By using a negative feedback loop formed by the operational amplifier OP3 and selective ones of the 4 transistors NM0, the drain voltages of the selective ones of the 4 transistors NM0 are set to be equal to the second reference voltage Vcres.

In the above power supply circuit, the current ratio Ko between the input branch and the output branch is determined by a ratio of number of the transistors in the second current mirror, i.e. Ko=N/M, where M represents the number of selected ones of the 4 transistors NM0 in the input branch, and N represents the number of selected ones of the 4 transistors NM11 in the output branch.

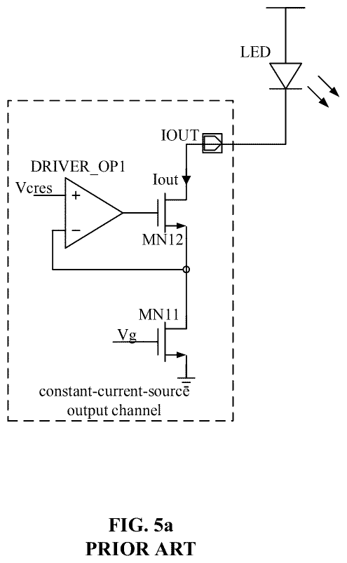

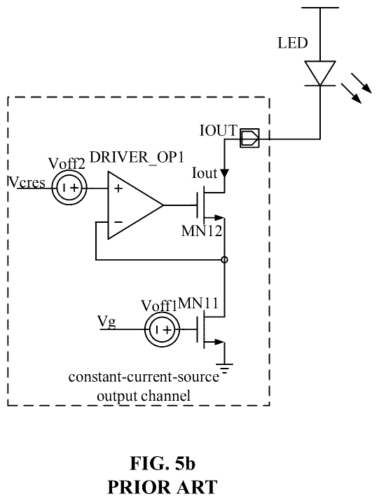

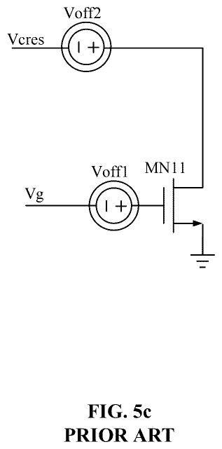

As shown in FIG. 5A to FIG. 5C, these are equivalent-circuit schematic views of the equivalent structures of constant-current-source output channels of the conventional power supply circuits in the LED module panel, wherein FIG. 5A shows the circuit diagram for connecting the output channel of the constant-current source and the light-emitting diode LED. Assuming that only the error introduced by the mismatch of the device is considered as the main error source of the constant-current source, there are two main error sources of the constant-current-source output channel: Voff1 (the equivalent offset voltage of the threshold voltage of the NMOS transistor that constitutes the current mirror) and Voff2 (the equivalent input offset voltage of OP22). The circuit shown in FIG. 5A can be equivalent to the equivalent circuit shown in FIG. 5B, and further, can be equivalent to the equivalent circuit shown in FIG. 5C; and then the current of the output constant-current source in FIG. 5A is equivalent to the current of the biased NMOS transistor shown in FIG. 5C.

In practical applications, the relationship (ignoring some second-order effects) between the current of NMOS transistor and the voltages of its gate and drain satisfies the following formula (1):

$${I}_{DS} = μ {C}_{OX} \frac{W}{L} [ ( {V}_{GS} - {V}_{TH} ) {V}_{DS} - \frac{1}{2} {V}_{DS}^{2} ] \qquad ( 1 )$$

where μ is channel carrier mobility; COX is gate oxide-layer capacitance per unit area; W/L is the width to length ratio of MOS transistor; VGS is the voltage between the gate and the source of MOSFET; VDS is the voltage between the drain and the source of MOSFET; and VTH is the threshold voltage of the MOSFET.

The ratio

$$\frac{Δ {I}_{1}}{{I}_{DS}}$$

of the current error introduced by the voltage Voff1 to the drain-source current IDS and the ratio

$$\frac{Δ {I}_{2}}{{I}_{DS}}$$

of the current error introduced by the voltage Voff2 to the drain-source current IDS are calculated, respectively, then formula (2) and formula (3) can be obtained, the calculation process is as follows.

$$\begin{matrix}\frac{Δ {I}_{1}}{{I}_{DS}} = \frac{\partial {I}_{DS}}{\partial {V}_{GS}} \frac{{V}_{off 1}}{{I}_{DS}} \\ = \frac{{μC}_{OX} \frac{W}{L} {V}_{DS} {V}_{off 1}}{{μC}_{OX} \frac{W}{L} [ ( {V}_{GS} - {V}_{TH} ) {V}_{DS} - \frac{1}{2} {V}_{DS}^{2} ]} \\ = \frac{{V}_{off 1}}{{V}_{GS} - {V}_{TH} - \frac{1}{2} {V}_{DS}}\end{matrix} \qquad ( 2 )$$

$$\begin{matrix}\frac{Δ {I}_{2}}{{I}_{DS}} = \frac{\partial {I}_{DS}}{\partial {V}_{GS}} \frac{{V}_{off 2}}{{I}_{DS}} \\ = \frac{{μC}_{OX} \frac{W}{L} ( {V}_{GS} - {V}_{TH} - {V}_{DS} ) {V}_{off 2}}{{μC}_{OX} \frac{W}{L} [ ( {V}_{GS} - {V}_{TH} ) {V}_{DS} - \frac{1}{2} {V}_{DS}^{2} ]} \\ = \frac{( {V}_{GS} - {V}_{TH} - \frac{1}{2} {V}_{DS} ) {V}_{off 2} - \frac{1}{2} {V}_{DS} {V}_{off 2}}{( {V}_{GS} - {V}_{TH} - \frac{1}{2} {V}_{DS} ) {V}_{DS}}\end{matrix} \qquad ( 3 )$$

Therefore, the followings can be obtained.

$$\frac{Δ {I}_{1}}{{I}_{DS}} = \frac{{V}_{off 1}}{{V}_{GS} - {V}_{TH} - \frac{1}{2} {V}_{DS}}$$

$$\frac{Δ {I}_{2}}{{I}_{DS}} = \frac{{V}_{off 2}}{{V}_{DS}} - \frac{1}{2} \frac{{V}_{off 2}}{( {V}_{GS} - {V}_{TH} - \frac{1}{2} {V}_{DS} )}$$

Formulas (2) and (3) indicate that the greater the gate-source voltage of the second transistor NM11 is, the smaller the impact of the error source introduced by the offset on the output current Iout is.

In practical application scenarios, in case that the channel current varies from a few milliamps to tens of milliamps, as the circuit connection state of the power supply circuit 200 during normal operation shown in FIG. 3, it can be obtained that VDS remains unchanged and is equal to the internally set voltage Vcres. According to the formula (1), reducing W/L (that is, reducing the number of the second transistors NM1) is equivalent to increasing VGS voltage. Therefore, when the output current Iout is small, only the first switch K0:1 and the second switch K1:1 are turned on, and the accuracy of the power supply circuit 200 at this time is the best. As the output current Iout increases and exceeds the capabilities of the first transistor NM0:1 and the second transistor NM1:1, the first switch K0:2 and the second switch K1:2 are turned on. In this way, as the set output current Iout increases, the first switches K0:1 to K0:4 and the second switches K1:1 to K1:4 are individually turned on, that is, less groups of NMOS transistors are turned on when the output current Iout is small, thereby increasing the current accuracy of the chip.

In general, the current range of the constant-current source is large, from several milliamps to tens of milliamps. Adopting MOSFETs of the same size in such a large range will lead to a large change on the current accuracy. Thus, the embodiment provides an idea of grouping: for different output current settings, different numbers of MOS transistors are turned on, thereby different groups adapt to different currents, which improves the current accuracy of the chip during the great variation of the current.

In the above power supply circuit 200, by selecting an appropriate current ratio M:N of the first transistor NM0 to the second transistor NM1, the static power consumption of the chip is reduced under the premise of ensuring the current accuracy. By adding a buffer 34 on the channel of the gate voltage VGATE of the current mirror NMOS transistor, the requirement for driving capability of the operational amplifier OP3 is reduced, the feedback noise is decreased, and the current accuracy is ensured and meanwhile the stability of the negative feedback loop between the operational amplifier OP3 and the first transistor NM0 is improved. The constant-current source adopts the grouping mode, which effectively guarantees the current accuracy within the entire current range of the output constant-current source.

In the above conventional power supply circuit, the controller 1 determines the current ratios of the plurality of output branches 32_1 to 32_n according to specifications of a display screen, such as different brightness requirements and different LED configurations. This allows the power supply circuit to balance power consumption and performance of the display screen. Furthermore, the buffer 34 is arranged before both input branch 31 and the plurality of output branches 32_1 to 32_n, and has only the function of providing driving capacity sufficient for all of the mirrored transistors in the input branch 31 and the plurality of output branches 32_1 to 32_n. The buffer 31 has not function of isolating the input branch 31 and the plurality of output branches 32_1 to 32_n. Thus, the power supply circuit 200 improves compatibility with the display screen by controlling on and off states of the switches in the current mirror circuit 30 to set multi-channel of output currents in a wide range.

However, due to the impact of switching actions of the plurality of output branches 32_1 to 32_n on a negative feedback circuit of the input branch 31, the current ratios of the second current mirror are not allowed to be dynamically adjusted between frames or between different lines within a single frame. Thus, the conventional power supply circuit 200 does not allow dynamical adjustment of the current ratios of the plurality of output branches 32_1 to 32_n according to grayscale levels of pixels of an image.

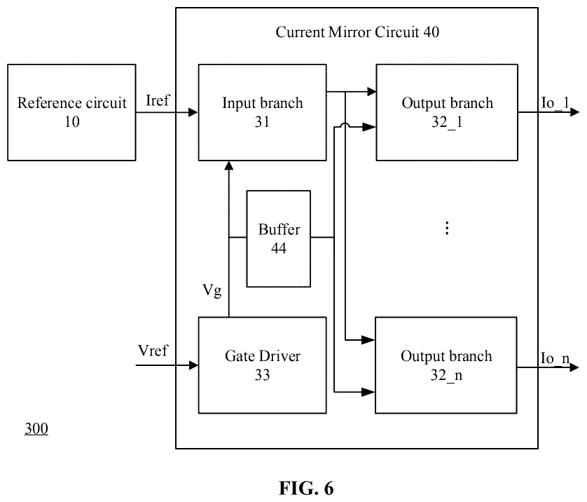

FIG. 6 illustrates a schematic block diagram of a power supply circuit in the LED module panel according to an embodiment of the present disclosure. The power supply circuit 300 includes a reference circuit 10 and a current mirror circuit 40.

The reference circuit 10 generates a reference current Iref, and the current mirror circuit 40 is coupled with the reference circuit 10 and mirror the reference current Iref to a plurality of output currents Io_1 to Io_n. Thus, the power supply circuit 300 has a plurality of output channels, each of which functions as a current source 1002 shown in FIG. 1.

The current mirror circuit 40 includes an input branch 31 and a plurality of output branches 32-1 to 32_n, and a gate driver 33. The input branch 31 receives the reference current Iref, and each of the plurality of output branches 32-1 to 32_n is coupled with the input branch 31 and generates respective one of the output currents Io_1 to Io_n. The gate driver 33 generates a gate driving signal Vg according to a first reference voltage Vref, and provides the gate driving signal Vg to the input branch 31 and the plurality of output branches 32-1 to 32_n.

Moreover, the current mirror circuit 40 includes a buffer 44 which is arranged between the input branch 31 and the plurality of output branches 32-1 to 32_n. Each of the plurality of output branches 32-1 to 32_n receives the gate driving signal Vg through the buffer 44. Here, the buffer 44 has not only the function of providing driving capacity sufficient for all of the mirrored transistors in the input branch 31 and the plurality of output branches 32_1 to 32_n, but also the function of isolating the plurality of output branches 32_1 to 32_n from the input branch 31 and the gate driver 33. This avoids the impact of the switching actions of the plurality of output branches 32_1 to 32_n on a negative feedback circuit of the input branch 31.

The gate driver 33 is typically a closed-loop negative feedback circuit which generates a stable gate driving signal Vg. Switching actions of the plurality of output branches 32_1 to 32_n will introduce transient fluctuations into the negative feedback circuit, which will affect the stability of the gate driver.

As mentioned above, switching actions of current or voltage can introduce several issues in power supply circuits, particularly those involving a negative feedback loop. These issues include transient overshoot and undershoot, loop gain variation, and parasitic oscillations. Transient fluctuations caused by switching actions can lead to voltage overshoot or undershoot in the gate driver, causing the output voltage to deviate from the set value and affecting the precision of the output current. Additionally, noise or fluctuations introduced by switching actions can cause instantaneous changes in the loop gain of the negative feedback circuit, thereby reducing the system's ability to maintain stability. For highly sensitive feedback circuits, switching actions can induce parasitic oscillations, which can further degrade system reliability. In stability design, a key focus is on enhancing the negative feedback circuit's ability to resist such interference and maintain consistent performance.

To mitigate the impact of switching actions and ensure the stability of the negative feedback circuit even under external interference, key considerations in stability design include loop bandwidth selection, compensation network design, and shielding and isolation techniques. Appropriately reducing the loop bandwidth can minimize the influence of high-frequency noise, though this may come at the cost of some regulation speed, necessitating a balance between these factors. Enhancing the dynamic response of the negative feedback circuit through compensation networks, such as adding capacitors or resistor networks, can prevent parasitic oscillations. Additionally, in circuit layout, shielding or signal isolation techniques can be employed to reduce the coupling of switching action noise.

After thorough evaluation, the inventor arranges a buffer 44 at the location between the input branch 31 and the plurality of output branches 32_1 to 32_n. This avoids increased complexity of the power supply circuit, because the buffer 44 is an original module, and has new function of isolation after being arranged at a new location. The design avoids challenges associated with implementing a compensation network in the power supply circuit 300.

The inventor further extends the applications of the power supply circuit 300 in a display screen from static adjustments of the output currents in view of the specification of the display screen to dynamic adjustments of the output currents in view of grayscale levels of pixels in an image, because the impact of the switching actions of the output branches on the gate driver is alleviated.

The output channels of the power supply circuit 300 function as constant current sources, which can be modulated using either pulse width modulation (PWM) by adjusting the on-time of the constant current source), or pulse amplitude modulation (PAM) by adjusting the current of the constant current source). Each adjustment of the output current directly alters the state of the first and second switches.

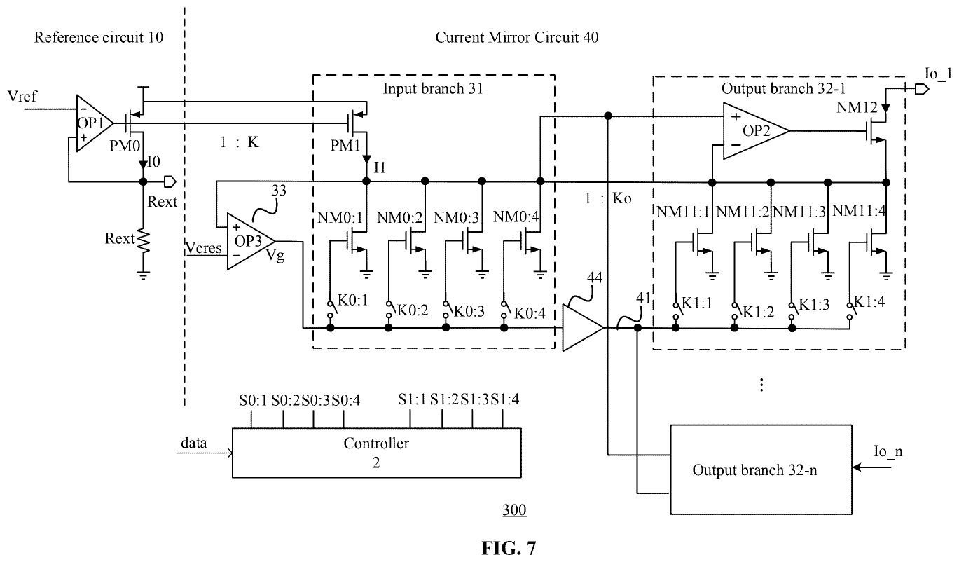

FIG. 7 illustrates a schematic circuit diagram of a first example of a power supply circuit in the LED module panel according to an embodiment of the present disclosure. Compared with the block diagram shown in FIG. 6, More detailed description of the power supply circuit 300 are shown in FIG. 7.

The power supply circuit 300 includes a reference circuit 10, a current mirror circuit 40, and a controller 2.

The reference circuit 10 in the second example is the same as that in FIG. 4 and the same reference numerals are used for the same components, and detailed description of the reference circuit 10 will be omitted.

The current mirror circuit 300 includes an input branch 31 and a plurality of output branches 32-1 to 32_n, a gate driver 33, and a buffer 44. The input branch 31 receives the reference current Iref, and each of the plurality of output branches 32-1 to 32_n is coupled with the input branch 31 and generates respective one of the output currents Io_1 to Io_n. The gate driver 33 generates a gate driving signal Vg according to a first reference voltage Vref.

Different from the conventional power supply circuit, the gate driver 33 provides the gate driving signal Vg to the input branch 31, directly or through a first driving line, and to the plurality of output branches 32-1 to 32_n through the buffer 44 and a second driving line.

The power supply circuit 300 has a plurality of output branches 32-1 to 32_n to provide multi-channel of output currents. One input branch 31 is shared by the plurality of output branches 32-1 to 32_n in the power supply circuit 100, thereby reducing the overall circuit cost. Moreover, one gate driver 33 is shared by the input branch 31 and the plurality of output branches 32-1 to 32_n to drive mirrored transistors. The buffer 44 is coupled with the gate driver 33 to provide driving capacity sufficient for all the input branch and the plurality of output branches 32-1 to 32_n.

The input branch 31 includes a transistor PM1, 4 transistors NM0, and 4 first switches K0. The 4 transistors NM0 are coupled in parallel with each other, and then the transistors PM1 is coupled with the 4 transistors NM0 between the power supply and the ground. The gate of transistor PM1 is coupled with the gate of transistor PM0, and the source of transistor PM1 is coupled with the source of transistor PM0, forming a first current mirror with a current ratio of K.

Each of the plurality of output branches 32_1 to 32_n includes 4 transistors NM11, a transistor NM12, 4 second switches K1, and an operational amplifier OP2. The 4 transistors NM11 are coupled in parallel, and then the transistor NM12 is coupled with the 4 transistors NM11 between the power supply and the ground. The gates of the 4 transistors NM0 in the input branch 31 are coupled to the driver 33 through respective ones of the 4 first switches K0. The gates of the 4 transistors NM11 in each of the plurality of output branches 32_1 to 32_n are coupled to a common driving line 41 through respective ones of the 4 second switches K1. A non-inverting input terminal of the operational amplifier OP2 is coupled with an intermediate node between the 4 transistors NM11 and the transistor NM12, and an inverting input terminal of the operational amplifier OP2 is coupled with an intermediate node between the transistors PM1 and the 4 transistors NM0. Further, an output terminal of the operational amplifier OP2 is coupled with a gate of the transistor NM12. By using a negative feedback loop formed by the operational amplifier OP2 and the transistor NM12, the drain voltage of transistor NM11 is set to be equal to the drain voltage of NM0.

The buffer 44 is arranged between the input branch 31 and a common node of the plurality of output branches 32_1 to 32_n. Specifically, an input terminal of the buffer 44 is coupled to the driver 33 directly or through a driving line, and an output terminal of the buffer 44 is coupled with the driving line 44 and is shared by the plurality of output branches 32_1 to 32_n. The buffer 44 has not only the function of providing driving capacity sufficient for all of the mirrored transistors in the input branch 31 and the plurality of output branches 32_1 to 32_n, but also the function of isolating the plurality of output branches 32_1 to 32_n from the input branch 31 and the gate driver 33.

The controller 2 generates 4 first switching control signals S0 and 4 second switching control signals Si, to control on and off states of the 4 transistors NM0 and the 4 transistors NM11. Thus, the 4 transistors NM0 and the 4 transistors NM11 form a second mirror with a current ratio of Ko, when at least one of the 4 transistors NM0 and at least one of the 4 transistors NM11 are selected. The current ratio Ko between the input branch and the output branch is determined by a ratio of number of the transistors in the second current mirror, i.e. Ko=N/M, where M represents the number of selected ones of the 4 transistors NM0 in the input branch, and N represents the number of selected ones of the 4 transistors NM11 in the output branch.

Different from the controller in the conventional power supply circuit, the controller 2 in the power supply circuit 300 receives display data of an image and dynamically adjusts the output currents in view of grayscale levels of pixels in the image. In PAM, dynamic adjustment of the output current is achieved by modulating the current ratio Ko between the input branch 31 and each of the plurality of output branches 32_1 to 32_n. In PWM, dynamic adjustment of the output current is achieved by modulating the duty ratio of the mirror transistors of the input branch 31 and each of the plurality of output branches 32_1 to 32_n.

The gate driver 33 may be an operation amplifier OP3, with an inverting input terminal for receiving a second reference voltage Vcres, a non-inverting input terminal being coupled with the intermediate node between the transistor PM1 and the 4 transistors NM0, and an output terminal being coupled with the driving line 41 through the buffer 44, and then with the 4 transistors NM0 in the input output branch 31 through respective ones of the 4 first switches K0, and then with the 4 transistors NM11 in each of the plurality of output branches 32_1 to 32_n through respective ones of the second switches K1. The gate driver 33 generates a gate driving signal Vg. By using a negative feedback loop formed by the operational amplifier OP3 and selective ones of the 4 transistors NM0, the drain voltages of the selective ones of the 4 transistors NM0 are set to be equal to the second reference voltage Vcres.

In the above power supply circuit, the current ratio Ko between the input branch and the output branch is determined by a ratio of number of the transistors in the second current mirror, i.e. Ko=N/M, where M represents the number of selected ones of the 4 transistors NM0 in the input branch, and N represents the number of selected ones of the 4 transistors NM11 in the output branch.

According to this embodiment, the current ratios between the input branch and each of the output branches can be dynamically adjusted between frames or between different lines within a single frame, as the input branch and each output branch are isolated by the buffer therebetween. The applications of the power supply circuit 300 in a display screen can be expanded from static adjustments of the output currents based on the display screen's specifications to dynamic adjustments based on the grayscale levels of pixels in an image. A driver chip incorporating this power supply circuit may eliminate the need for additional modules to modulate the output currents according to the grayscale levels of pixels.

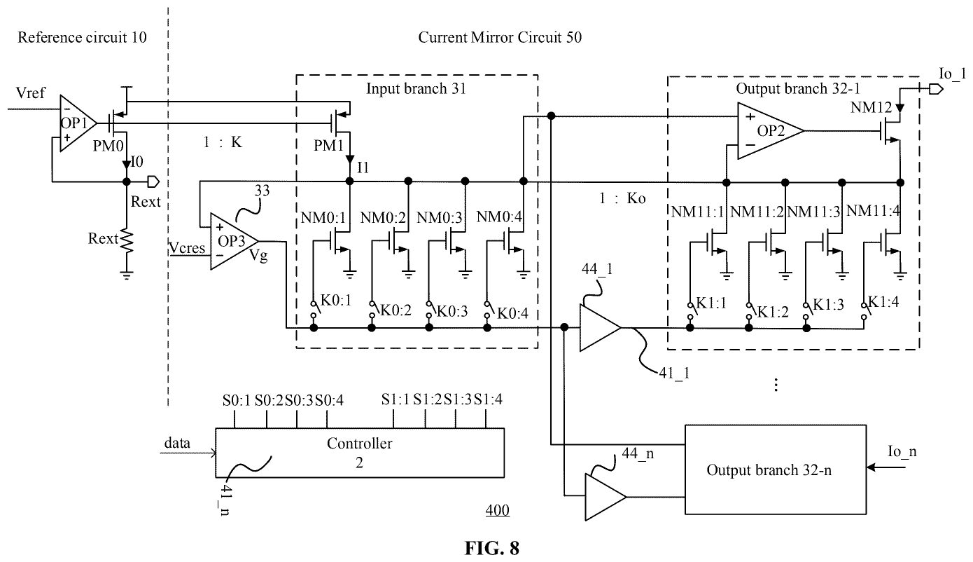

FIG. 8 illustrates a schematic circuit diagram of a second example of a power supply circuit in the LED module panel according to an embodiment of the present disclosure. The power supply circuit 400 includes a reference circuit 10, a current mirror circuit 50, and a controller 2.

The reference circuit 10 in the second example is the same as that in FIG. 4 and the same reference numerals are used for the same components, and detailed description of the reference circuit 10 will be omitted.

The current mirror circuit 300 includes an input branch 31 and a plurality of output branches 32-1 to 32_n, a gate driver 33, and a plurality of buffers 44_1 to 44_n. The input branch 31 receives the reference current Iref, and each of the plurality of output branches 32-1 to 32_n is coupled with the input branch 31 and generates respective one of the output currents Io_1 to Io_n. The gate driver 33 generates a gate driving signal Vg according to a first reference voltage Vref.

Different from the first example of the power supply circuit, the current miror circuit 50 includes a plurality of buffers 44_1 to 44_n and a plurality of driving lines 41_1 to 41_n. Each of the plurality of output branches 32-1 to 32_n is coupled with one of a plurality of buffers 44_1 to 44 through respective one of the plurality of driving lines 41_1 to 41_n. The gate driver 33 provides the gate driving signal Vg to the input branch 31 directly or through a driving line, and to the plurality of output branches 32-1 to 32_n through respective ones of the plurality of buffers 44_1 to 44_n.

Other aspects of the second example are the same as the first example according to the embodiment of the present disclosure, and detailed description is omitted here. According to this embodiment, the input branch and each of the plurality of output branches are isolated by respective buffer therebetween. Furthermore, any two of the plurality of output branches are isolated from each other by two buffers therebetween. The plurality of buffer improves not only stability of the negative feedback circuit of the gate driver, but also stability of the negative feedback circuit in each of the plurality of output branches.

Further, the embodiment of the present disclosure provides a display screen comprising the power supply circuit provided in the forgoing embodiment, wherein the common anode of the power supply circuit drives the display screen; or the common cathode of the power supply circuit drives the display screen. Therefore, this embodiment has all the beneficial effects of the power supply circuit in the above embodiment. For details, referring to the description of the above-mentioned embodiments, description will not be repeated herein. Optionally, the display screen can be an LED display screen.

Although the embodiments of the present disclosure have been described in conjunction with the drawings, various modifications and variations can be made by those skilled in the art without departing from the spirit and scope of the present disclosure, and such modifications and variations fall within the scope defined by the appended claims.

### INDUSTRIAL PRACTICALITY

The technical solution provided by the present disclosure minimizes the impact of the constant-current-source switching on the accuracy of the output current, improves the stability of the internal loop, and effectively improves the current accuracy within the entire current range of the output constant-current source.

1. A power supply circuit comprising:
a reference circuit, configured to generate a reference current;
a current mirror circuit, configured to be coupled with the reference circuit and mirror the reference current to a plurality of output currents,
wherein the current mirror circuit comprises:
a gate driver, configured to generate a gate driving signal according to a first reference voltage;
an input branch, which receives the gate driving signal and generates an input current according to the gate driving signal; and
a plurality of output branches, each of which receives the gate driving signal through a buffer between the input branch and the plurality of output branches, and generates one of the plurality of output currents according to the gate driving signal.

2. The power supply circuit according to claim 1, wherein
the plurality of output branches are coupled with the buffer through a common driving line, so that the buffer is shared by the plurality of output branches.

3. The power supply circuit according to claim 1, wherein
each of the plurality of output branches is coupled with one of a plurality of buffers through respective one of a plurality of driving lines, so that the buffer is dedicated to one of the plurality of output branches.

4. The power supply circuit according to claim 1, wherein the input branch comprises:
a plurality of first switches; and
a plurality of first transistors,
wherein
a drain of each of the first transistors receives the reference current at an input terminal of the input branch, respectively;
a gate of each of the first transistors receives the gate driving signal through one of the plurality of first switches; and
a source of each of the first transistors is grounded.

5. The power supply circuit according to claim 4, wherein the gate driver comprises:
a first operational amplifier,
an inverting input terminal of the first operational amplifier receiving the first reference voltage, and
a non-inverting input terminal of the first operational amplifier being coupled to the input terminal of the input branch, and an output terminal of the first operational amplifier being coupled to the gate of each of the first transistors through one of the first switches.

6. The power supply circuit according to claim 4, wherein
each of the plurality of first transistors is an NMOS transistor.

7. The power supply circuit according to claim 5, wherein
each of the plurality of output branches comprises:
a plurality of second switches;
a plurality of second transistors;
an output transistor; and
a second operational amplifier,
wherein a non-inverting input terminal of the second operational amplifier is coupled to the input terminal of the input branch, and an output terminal of the second operational amplifier is coupled to the output transistor,
a drain of each of the second transistors is coupled to an inverting input terminal of the second operational amplifier, a gate of each of the second transistors is coupled to the output terminal of the first operational amplifier through one of the plurality of second switches, and a source of each of the second transistors is grounded.

8. The power supply circuit according to claim 7, wherein
each of the plurality of second transistors is an NMOS transistor.

9. The power supply circuit according to claim 7, wherein
the power supply circuit further comprises:
a controller, configured to control on and off states of the plurality of first switches and the plurality of second switches, so as to change current ratios of the plurality of output branches.

10. The power supply circuit according to claim 9, wherein
the controller determines the current ratios of the plurality of output branches according to specifications of a display screen.

11. The power supply circuit according to claim 9, wherein
the controller determines the current ratios of the plurality of output branches according to grayscale levels of pixels of an image.

12. The power supply circuit according to claim 9, wherein
the controller determines predetermined current ratios of the plurality of output branches and duty ratios of the plurality of output currents according to grayscale levels of pixels of an image.

13. The power supply circuit according to claim 1, wherein
the reference circuit comprises:
an operational amplifier, wherein
an inverting input terminal of the operational amplifier receives a second reference voltage; and
an external resistor, wherein
a first terminal of the external resistor is coupled to a non-inverting input terminal of the operational amplifier, and a second terminal of the external resistor is grounded.

14. The power supply circuit according to claim 13, wherein the reference circuit further comprises:
a third transistor, wherein a gate of the third transistor is coupled to an output terminal of the operational amplifier, a drain of the third transistor is coupled to the first terminal of the external resistor, and a source of the third transistor is grounded; and
a fourth transistor, wherein a gate of the fourth transistor is coupled to the output terminal of the operational amplifier, a drain of the fourth transistor is respectively coupled to the drain of each of the first transistors, and a source of the fourth transistor is grounded.

15. A driver chip, comprising the power supply circuit according to claim 1, wherein the power supply circuit provides the plurality of output currents to light-emitting diodes to display an image.

16. A display screen, comprising:
a plurality of light-emitting diodes; and
the driver chip according to claim 15,
wherein anodes of the plurality of light-emitting diodes are coupled to a control line, and cathodes of the plurality of light-emitting diodes are coupled to respective ones of a plurality of output terminals of the driver chip; or
cathodes of the plurality of light-emitting diodes are coupled to a control line, and anodes of the plurality of light-emitting diodes are coupled to respective ones of a plurality of output terminals of the driver chip.
